(19) United States
(12) Patent Application Publication
(10) Pub. No.: US 2007/0270190 A1
(43) Pub. Date: Nov. 22, 2007

(54) METHOD AND SYSTEM FOR SUPPRESSING ECHO DURING A HANDOVER

(75) Inventors: DAVID D. HISKY, SUNRISE, FL (US); ANIL N. PATEL, CORAL SPRINGS, FL (US); DAVID N. TAYLOR, PLANTATION, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/383,891

(22) Filed: May 17, 2006

(51) Int. Cl. H04B 1/38

(52) U.S. Cl. 455/570

(57) ABSTRACT

A system (160) and method (500) is provided for suppressing an echo during a handover between two networks. During a handover from a first network (110) to a second network (140), a microphone to the second network can be muted (506) to suppress an echo. The handover to the second network can be conducted while maintaining a connection with the first network. Upon connecting to the second network, the microphone to the first network can be muted (510), and a network switch (512) can be performed while the microphone is muted on the first network and also muted on the second network. The microphone on the second network can then be un-muted (514) and the first call on the first network can be terminated.

### FIELD OF THE INVENTION

The present invention is relates to echo suppressors and, more particularly, to methods of suppressing echo during a handover.

### BACKGROUND

The use of portable electronic devices and mobile communication devices has increased dramatically in recent years. Mobile communication devices are capable of establishing communication with other communication devices over landline networks, cellular networks, and, recently, wide local area networks (WLANs). The communication protocols and infrastructure generally required to support a cellular system is sufficiently different from that of a WLAN system. For example, the communication network can operate on CDMA, OFDM, WiMAX, iDEN, WiDEN, and the WLAN network can operate over IEEE 802.11, 802.16, and 802.xx standards.

When a user of a mobile communication device moves to new geographical regions or coverage areas, the mobile communication device can automatically switch a network coverage. Alternatively, a user may selectively switch to a different network for accessing a feature or receiving services unavailable to the current network. The mobile communication device can automatically switch to the other network during a handover period. During the handover period, call setup and control information is passed between the networks for connecting and disconnecting the mobile communication device. In certain cases, the network switch may occur during a call while a user is talking on the mobile communication device. However, when a user is talking during handover, an echo of the user's voice can be generated which the user can hear. The echo can be a source of annoying frustration when the user is speaking and hearing their own voice. A need therefore exists for suppressing echo during handover.

### SUMMARY

Embodiments of the invention are directed to a method for suppressing echo on a mobile device during a handover. The method can include connecting a first call to a first network, and handing over to a second network while connected to the first network. During the handing over to the second network, a microphone on a mobile device connected to the second network can be muted. Upon connecting to the second network, the microphone to the first network can be muted. With the microphones to both networks muted, the mobile device can switch from the first network to the second network. The muting of the microphone to the first network and the second network can prevent or suppress echo during the handover. Upon completing the network switch, the microphone connected to the second network can be un-muted, and the first call to the first network can be released.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a diagram of a mobile communication environment;

FIG. 2 is diagram of a conference call example illustrating an echo path condition in accordance with the embodiments of the invention;

FIG. 3 is diagram of a mobile device supporting two network connections and illustrating an echo path condition in accordance with the embodiments of the invention;

FIG. 4 is a schematic of the processing components of a mobile device in accordance with the embodiments of the invention;

FIG. 5 is a flow chart describing a method for suppressing echo during hand-out in accordance with the embodiments of the invention;

FIG. 6 is a sequencing chart for hand-out in accordance with the embodiments of the invention;

FIG. 7 is a flow chart describing a method for suppressing echo during hand-out in accordance with the embodiments of the invention; and

FIG. 8 is a sequencing chart for hand-in in accordance with the embodiments of the invention;

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processor” can be defined as any number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

Embodiments of the invention provide a method for suppressing an echo during a handover between two or more networks. During a call connection on a first network, a second network can be identified for supporting a second call. During the handing over to the second network, a microphone on the mobile device connected to the second network can be muted to suppress an echo. The handover to the second network can be conducted while maintaining a connection with the first network. Upon connecting to the second network, the microphone to the first network can be muted, and a network switch can be performed while the microphone is muted on the first network and also muted on the second network. The microphone on the second network can then be un-muted and the first call on the first network can be terminated.

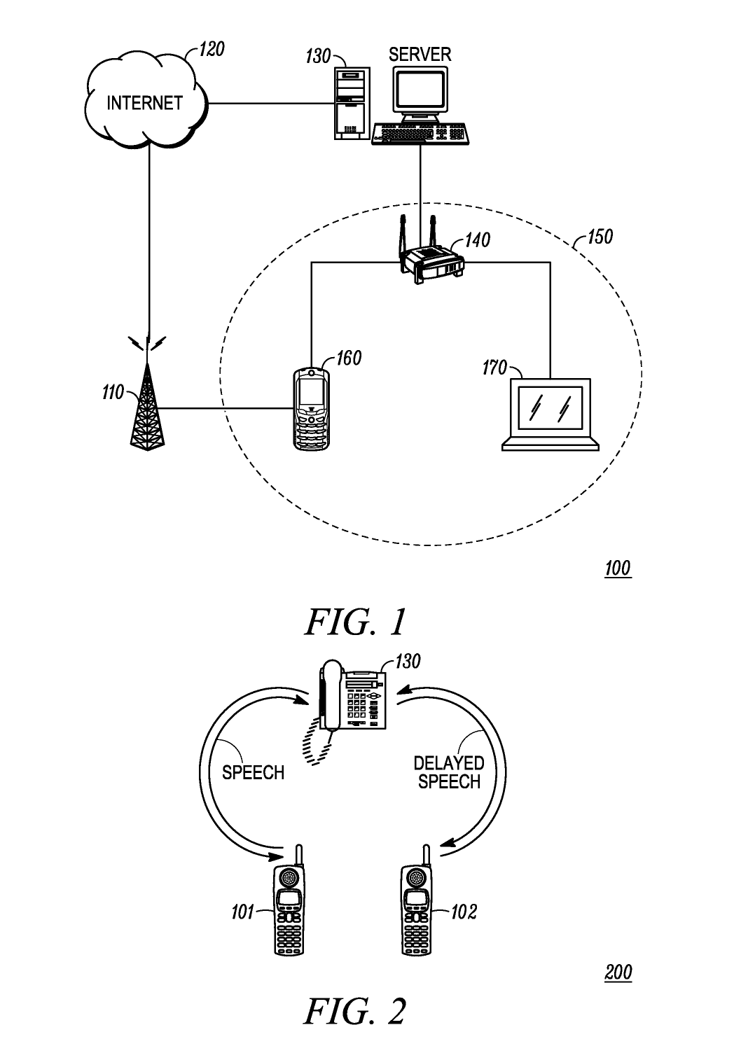

Referring to FIG. 1, a mobile communication environment 100 is shown. The mobile communication environment 100 can provide wireless connectivity over a radio frequency (RF) communication network or a Wireless Local Area Network (WLAN). Communication within the network 100 can be established using a wireless, copper wire, and/or fiber optic connection using any suitable protocol (e.g., TCP/IP, HTTP, etc.). In one arrangement, a mobile device 160 can communicate with a base receiver 110 using a standard communication protocol such as CDMA, GSM, or iDEN. The base receiver 110, in turn, can connect the mobile device 160 to the Internet 120 over a packet switched link. The internet 120 can support application services and service layers for providing media or content to the mobile device 160. The mobile device 160 can also connect to other communication devices through the Internet 120 using a wireless communication channel. The mobile device 160 can establish connections with a server 130 on the network and with other mobile devices 170 for exchanging data and information. The server can host application services directly, or over the internet 120.

The mobile device 160 can also connect to the Internet 120 over a WLAN. Wireless Local Access Networks (WLANs) provide wireless access to the mobile communication environment 100 within a local geographical area. WLANs can also complement loading on a cellular system, so as to increase capacity. WLANs are typically composed of a cluster of Access Points (APs) 140 also known as base stations. The mobile communication device 160 can communicate with other WLAN stations such as the laptop 170 within the base station area 150. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The mobile device 160 can send and receive data to the server 130 or other remote servers on the mobile communication environment 100.

In one example, the mobile device 160 can send and receive speech to and from the laptop 170 over the WLAN connection or the RF connection. For example, a user of the mobile device 160 can conduct a call to the laptop 170, or other mobile device within the mobile communication environment 100. Understandably, voice can be represented as packets of voice which can be transmitted to and from the mobile devices 160 to provide voice communication. The mobile device 160 can be a cell-phone, a personal digital assistant, a portable music player, or any other suitable communication device. The WLAN devices such as the mobile phone 160 and the laptop 170 can be equipped with a transmitter and receiver for communicating with the AP 140 according to the appropriate wireless communication standard. In one embodiment of the present invention, the wireless station 160 is equipped with an IEEE 802.11 compliant wireless medium access control (MAC) chipset for communicating with the AP 140. IEEE 802.11 specifies a wireless local area network (WLAN) standard developed by the Institute of Electrical and Electronic Engineering (IEEE) committee. The standard does not generally specify technology or implementation but provides specifications for the physical (PHY) layer and Media Access Control (MAC) layer. The standard allows for manufacturers of WLAN radio equipment to build interoperable network equipment.

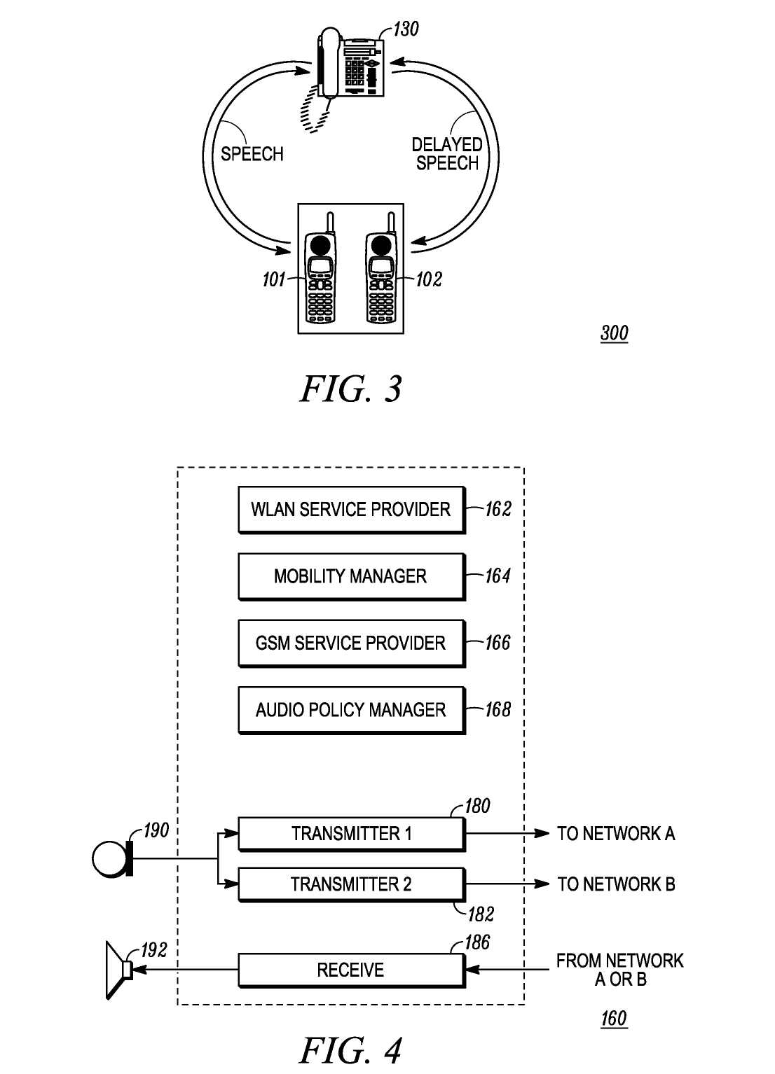

Referring to FIG. 2, a depiction of a conference call scenario with multiple communication devices is shown. The conference call illustration of FIG. 2 is a practical example for understanding echo issues concerning a handover process across two networks. In particular, the echo problems associated with a handover between a first network and a second network can be modeled as audio delays in a conference call. It should be noted that FIG. 2 is presented only for a didactive illustration of the echo path condition encountered during handover, and is not a part of the invention. That is, the method for handing over between a first network and a second network can be modeled as a conference call during the handover process. For example, in the scenario of FIG. 2, phone 101 hosts a conference with phone 102 and phone 130. Phone 130 can be a server, a PBX, an internet phone, or any such device or system capable of hosting a conference call. A user can speak into phone 101, and people listening on phone 102 and phone 103 can hear the person speak. Understandably, a system delay exists due to processing aspects involved in transmitting the audio across the mobile communication network 100 from phone 101 to phone 102. Consequently, the audio will be delayed by a small amount of time, preferably under 250 ms, thereby creating the echo. The delay exists with any of the phones used during the conference call.

In this example, the delayed speech can represent the echo. That is, if a user speaks into phone 101 and simultaneously listens to audio from the phone 101 and 102, the user will hear a delay of his speech (i.e. the echo). The delayed speech characterizes processing aspects of the mobile communication environment 100 that are similar to processing aspects involved during a handover from a first network to a second network. In this scenario, phone 101 represents the first network and phone 102 represents the second network. Accordingly, a handover between a first network, such as a GSM network, and a second network, such as a WLAN network, imparts a processing delay that results in an echo when a mobile device is connected to both the first network and the second network. Consequently, during a handover, a user will hear an echo of their voice.

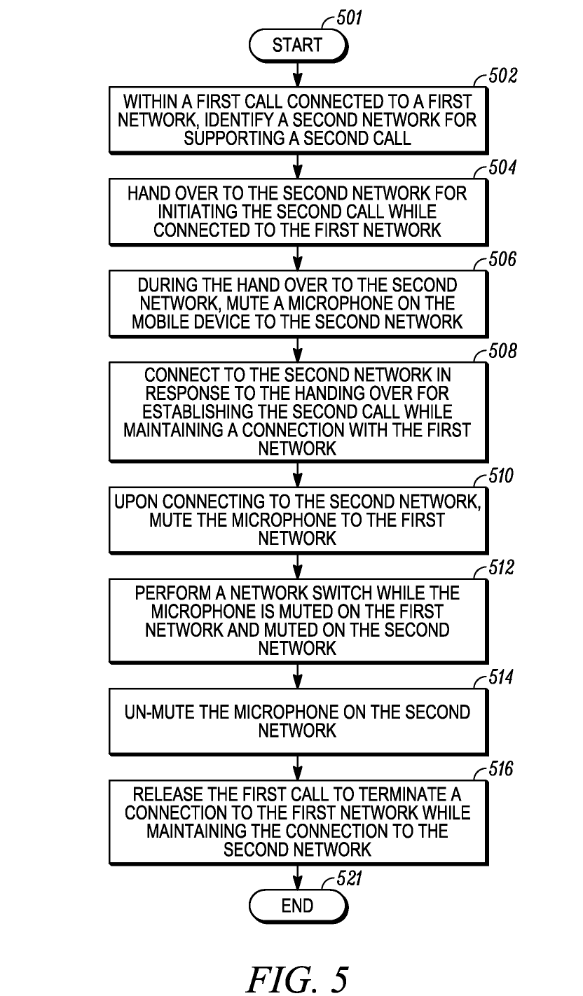

Referring to FIG. 3, another representation of the echo problem is illustrated. Similarly, FIG. 3 is provided only as a didactive illustration. In particular, phone 101 represents a WLAN network and phone 102 represents a GSM network that together can be considered the mobile device 160. Notably, the mobile device 160 can include a processor, such as a microprocessor or DSP, that can simultaneously serve communication to both a WLAN network and a GSM network. Accordingly, the mobile device 160 can simultaneously support data transmission to and from multiple networks thereby behaving as multiple distinct processes. For example, the mobile device 160 can include a modem with a transmit connection and a receive connection. In particular, the mobile device may have two transmit connections but only one receive connection. For example, the modem can include a single receive buffer for accepting incoming data, though may include two transmit buffers for sending outgoing data. Accordingly, when the mobile device 160 is supporting two network connections with only a single receive buffer, the two networks can both send data to the mobile device. Consequently, the mobile device will receive audio from both networks thereby creating an echo path condition. That is, when the mobile device is simultaneously connected to both networks, audio can be received from both networks which can be heard by the user. With regard to FIG. 3, the illustration of the two separate phones 101 and 102 is presented to show the separate and distinct processing capabilities of the mobile device 160 for supporting two network connections.

Similarly to FIG. 2, when the mobile device 160 is engaged in communication with both a WLAN network and a GSM network, an echo will be heard on the phone. That is, when a user speaks into the mobile device 160 while the mobile device is connected to both the GSM and WLAN networks, the user will hear their speech delayed (i.e. echo). When the mobile device is only connected to one network, there will be no echo, and the user will not hear their speech delayed. Understandably, the echo is generated when the mobile device 160 is connected simultaneously to both networks.

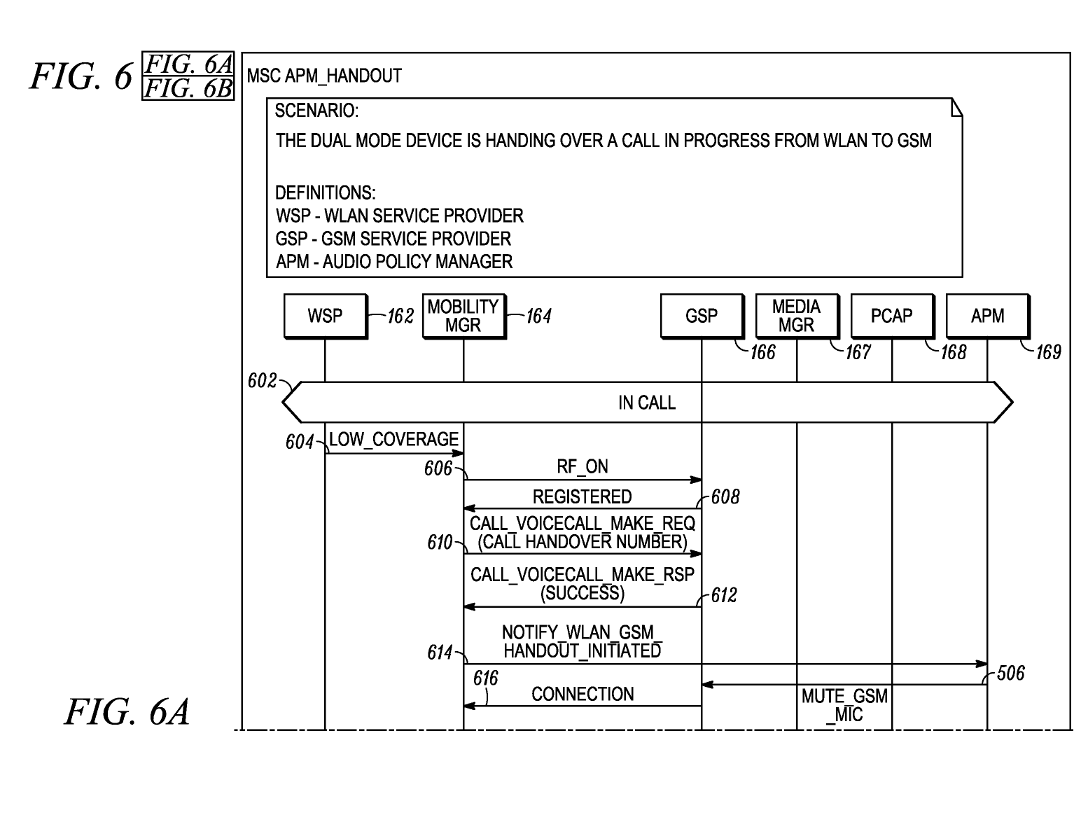

FIG. 4 shows components of the mobile communication device 160. The mobile device 160 can include a WLAN service provider (WSP) 162, a mobility manager 164, a GSM service provider (GSP) 166, and an audio policy manager (APM) 169. The mobility manager 164 can be communicatively coupled to the WSP 162 for sending and receiving handover requests to a WLAN network. The GSP 166 can be communicatively coupled to the mobility manager for supporting a GSM call. The audio policy manager (APM) can be communicatively coupled to the mobility manager and the GSP for sending and receiving handover requests to a GSM network. The mobile device 160 can also include a first transmitter 180 and a second transmitter 182. The transmitters can send voice data captured from the microphone 190 to one or more networks. The mobile device 160 can also include a receiver 186 for receiving data such as audio or voice. The receiver can play the received audio or voice out the speaker 192. For example, the first network can be GSM and the second network can be WLAN. Understandably, as described in the conference call illustration of FIG. 3, the transmitters 180 and 182 can simultaneously transmit data when the mobile device 160 is connected to both networks. During this condition, the a user listening on the device 160 can hear an echo out of the speaker. The echo can be a delayed version of the audio presented to the transmitters 180 and 182. For example, when a user is talking in the microphone 190, the echo is a delay of the user's voice. When the microphone picks up ambient sound such as music, the audio can be presented to the transmitters and received at a later time causing the echo. An echo can be at least a portion of a user's speech or audio captured by the microphone or sent to the transmitters.

In particular, the audio policy manager 169 can selectively mute and un-mute a microphone that has a common connection to the WLAN network and the GSM network. Mute can be defined as completely blocking acoustic information from entering a microphone 190 (See FIG. 4). Muting a microphone includes preventing audio from being captured. Muting can also be a substantial reduction in the level of captured audio; that is, the volume can be reduced. This can include software control which prevents data from arriving on an audio buffer, zeros out data on a buffer, or prevents data from being transmitted to and from a buffer. A buffer is a memory location which can store one or more samples that can be transmitted to or received from another source. An un-mute is release from a mute. That is, an un-muting releases resources associated with blocking audio. Un-muting can include activating the microphone to capture audio or software to allow for sampled audio capture. Un-muting can also elevate an intentionally lowered volume level to a pre-occurring volume level prior to a muting. The audio policy manager can also perform a network switch while the microphone is muted on the WLAN network and muted on the GSM network to suppress an echo occurring when the mobile device is connected to both the WLAN network and the GSM network. For example, the audio policy manager mutes the microphone on the mobile device to one or more networks during a handover.

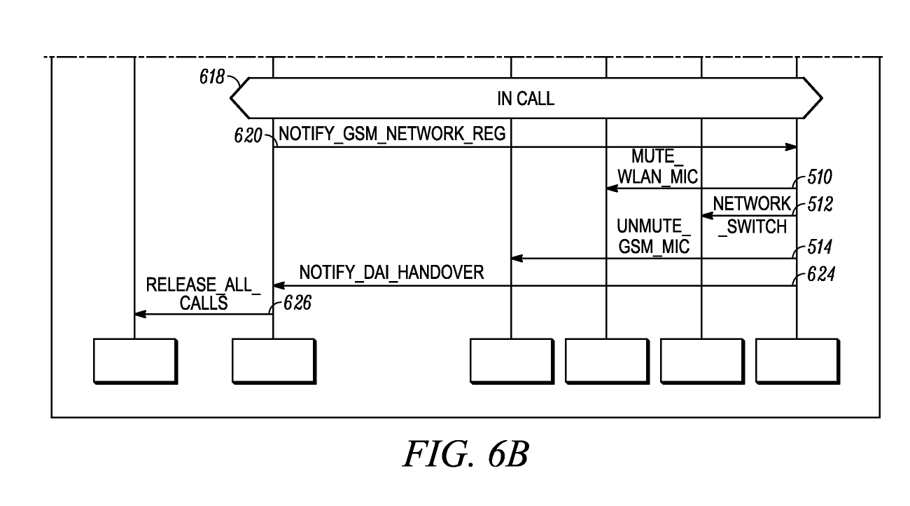

FIG. 5 shows a method 500 for suppressing echo during hand-out in accordance with the embodiments of the invention. The method 500 can be practiced with more or less that the number of steps shown. To describe the method 500, reference will be made to FIGS. 3 and 4, although it is understood that the method 500 can be implemented in any other suitable device or system using other suitable components. Moreover, the method 500 is not limited to the order in which the steps are listed in the method 500. In addition, the method 500 can contain a greater or a fewer number of steps than those shown in FIG. 5.

At step 501, the method can begin. At step 502, a first call can be connected to a first network, and a second network can be identified for supporting a second call. At step 504, a hand over to the second network can be performed for initiating the second call while connected to the first network. At step 506, a microphone on the mobile device can be muted to the second network during the handing over to the second network. At step 508, the second network can be connected in response to the handing over for establishing the second call while maintaining a connection with the first network. At step 510, upon connecting to the second network, the microphone to the first network can be muted. At step 512, a network switch can be performed while the microphone is muted on the first network and muted on the second network. At step 514, the microphone on the second network can be un-muted. And, at step 516, the first call can be released to terminate a connection to the first network while maintaining the connection to the second network. At step 521 the method can end.

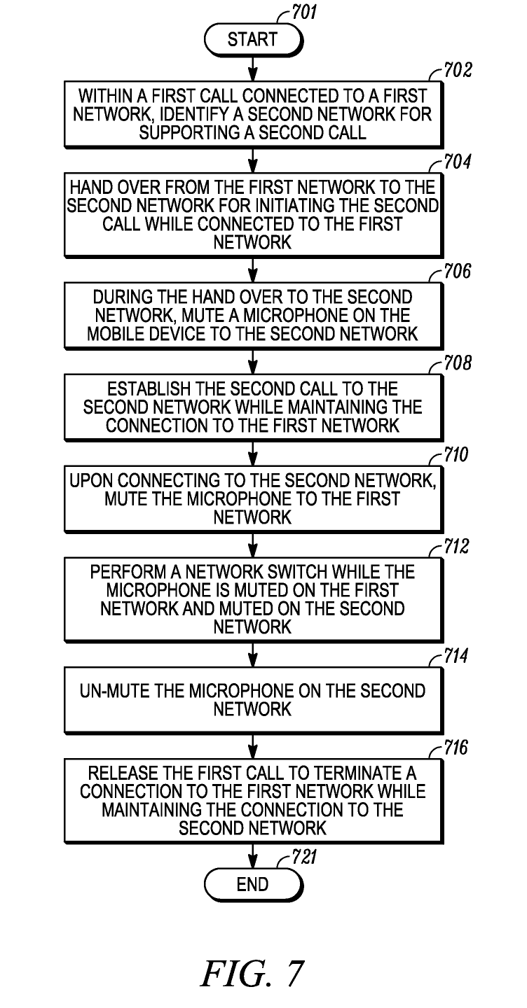

The hand-out method steps of FIG. 5 can be better understood with reference to a hand-in sequence chart. FIG. 6 shows a first sequence chart 600 for handing over from WLAN to GSM commonly referred to as a hand-out. When describing the sequence chart 600, reference will be made to FIGS. 1, 4, and 5. The sequence chart 600 shows the processing components 162-169 of the mobile device 160 shown in FIG. 4. A media manager 167 and a PCAP 168 can be included within the mobile device 160. The roles of the processing components 162-169 for connecting and disconnecting calls between a first and a second network are shown in the sequence chart 600. However, it should be noted that the processing responsibilities of the processing components 162-169 are not restricted to the responsibilities shown. The processing components can share processing load, or other processing components can be included for delegating these responsibilities. The processing components 162-169 are shown for exemplary purposes of describing the method 500.

The sequence chart 600 of FIG. 6 represents the sequence of events occurring during a hand-out from a WLAN network (140) to a GSM network (110). The sequence of events as they occur in time are presented from top to bottom. For example, at step 602, the mobile device 160 can be in a call on the WLAN network 140. At step 604, the WSP 162 can send an indication message to the mobility manager 164 indicating a low coverage condition on the WLAN network. The mobility manager 164 can initiate a handover request from the WLAN network in response to the low coverage indicator message. Upon receiving the indicator message, at step 606, the mobility manager 164 can turn on radio frequency transmission to register the mobile device with the GSM network.

At step 608, the GSP 166 can register the mobile device 160 for connection to the GSM network 110. In response, at step 610, the mobility manager 164 can issue a request to make a voice call which includes a handover number. The mobility manager 164 can await a success response to initiate a hand-out to the GSM network, at step 612. At step 614, the mobility manager 164 can notify the APM 169 that a WLAN to GSM hand-out has been initiated, and at 506, the APM 169 can mute the microphone to the GSM network 110 and inform the mobility manager 164 of the muted status (Step 506 corresponds to method step 506 in FIG. 5). At step 616, the GSP 166 can establish a connection to the GSM network and inform the mobility manager 164 of the connected status. Accordingly, at step 618, the mobile device 160 is connected to the second network (GSM 140), while simultaneously being connected to the first network (WLAN 110).

At step 620, the mobility manager 164 can inform the APM 169 that the mobile device connected to the WLAN network 140 is also connected to the GSM network 110. At step 510, the APM 169 can mute the microphone on the mobile device that is connected to the WLAN network 140. For example, the APM 169 can direct the Media Manager 167 to mute the microphone 190 (See FIG. 4). Recall, the mobile device can support two simultaneous calls through two transmit connections available to the processor on the mobile device. At this point, the audio path to both the GSM network and the WLAN network has been muted. Accordingly, at step 512, the APM 169 can perform a network switch while both audio paths are muted thereby suppressing an echo condition. For example, the APM 169 can direct the PCAP 168 to switch networks. The PCAP 169 is an application processor for communication including media and data. Clearly, if the APM 169 completely mutes the audio on the microphone, an echo will be prevented. Alternatively, if the APM 169 reduces the gain of the microphone(s), the echo will be suppressed. At step 514, the microphone to the GSM network can be un-muted. And, at step 624 the APM 169 can inform the mobility manager 164 that call is connected and active; that is, the audio can be transmitted. For example, the mobility manager 164 can notify a digital audio interface for providing clock frame synchronization for sending voice packets. At step 626, the mobility manager 164 can release the call to the WLAN network.

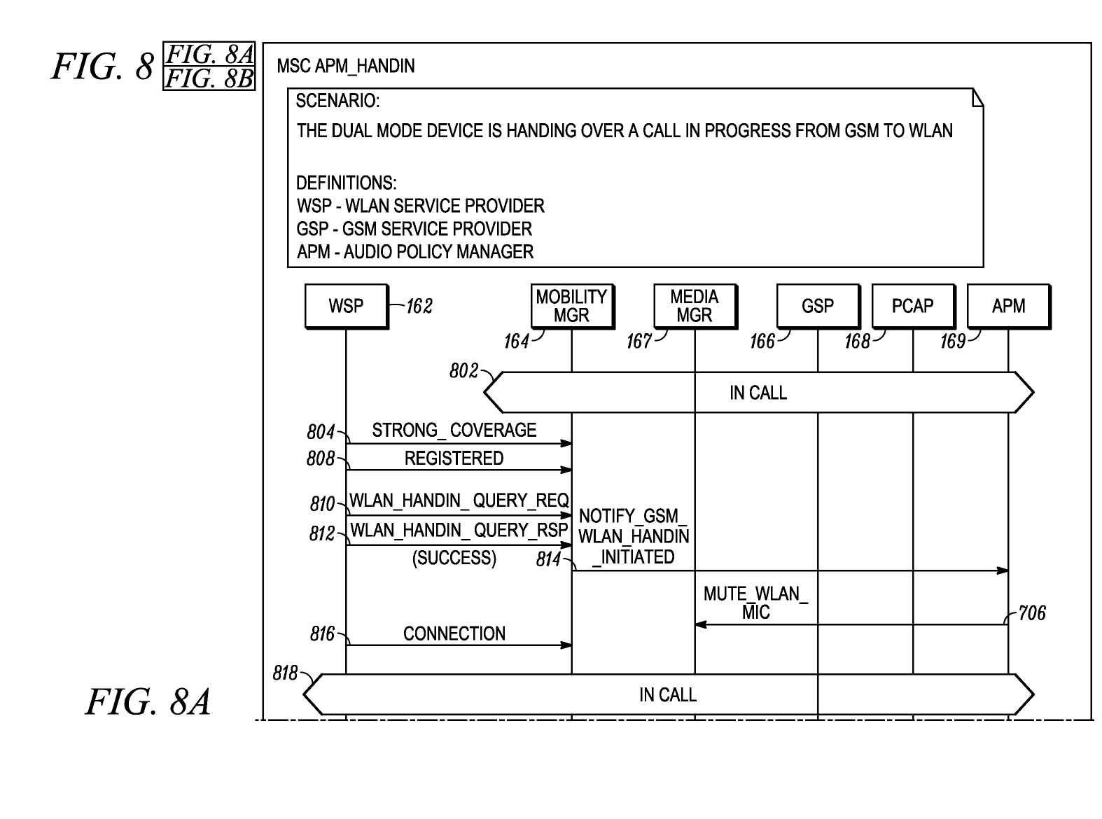

FIG. 7 shows a method 700 for suppressing echo during hand-in in accordance with the embodiments of the invention. The method 700 can be practiced with more or less that the number of steps shown. To describe the method 700, reference will be made to FIGS. 3 and 4, although it is understood that the method 700 can be implemented in any other suitable device or system using other suitable components. Moreover, the method 700 is not limited to the order in which the steps are listed in the method 700. In addition, the method 700 can contain a greater or a fewer number of steps than those shown in FIG. 7.

At step 701, the method can begin. At step 702, within a first call connected to a first network, a second network can be identified for supporting a second call. At step 704, a hand over from the first network to the second network can be conducted for initiating the second call while connected to the first network. At step 706, during the handing over to the second network, a microphone on the mobile device can be muted to the second network. At step 708, the second call to the second network can be established while maintaining the connection to the first network. Upon connecting to the second network, at step 710, the microphone to the first network can be muted. At step 712, a network switch can be performed while the microphone is muted on the first network and muted on the second network. At step 714, the microphone on the second network can be un-muted, and the first call can be released to terminate the connection to the first network at step 716. At step 721 the method can end.

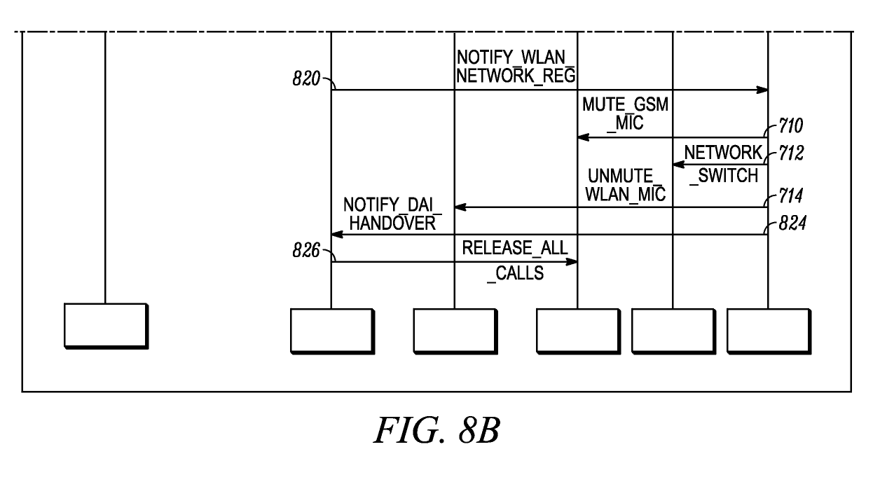

The hand-in method steps of FIG. 7 can be better understood with reference to a hand-in sequence chart. FIG. 8 shows a first sequence chart 800 for handing over from GSM to WLAN commonly referred to as a hand-in. When describing the sequence chart 800, reference will be made to FIGS. 1, 4, and 7. The sequence chart 800 shows the processing components 162-169 of the mobile device 160 shown in FIG. 4. That is, the roles of the processing components 162-169 for connecting and disconnecting calls between a first and a second network are shown. However, it should be noted that the processing responsibilities of the processing components 162-169 are not restricted to the responsibilities shown. The processing components can share processing load, or other processing components can be included for delegating these responsibilities. The processing components 162-169 are shown for exemplary purposes of describing the method 500.

The sequence chart 800 of FIG. 8 represents the sequence of events occurring during a hand-in from a GSM network (110) to a WLAN network (140). The sequence of events as they occur in time are presented from top to bottom. Notably, the sequence of events in 700 are the compliment of the sequence of events in 600. For example, at step 802, the mobile device 160 can be in a call on the GSM network 110. At step 804, the WSP 162 can send an indication message to the mobility manager 164 indicating a strong coverage condition on the WLAN network. The mobility manager 164 can initiate a handover request from the GSM network to the WLAN network in response to the strong coverage indicator message. Notably, the mobile device 160 has radio frequency transmission established on the GSM connection which also allows it to receive a registration from the WLAN network.

At step 808, the GSP 166 can register the mobile device 160 for connection to the WLAN network 110. In response, at step 810, the mobility manager 164 can issue a WLAN hand-in query request to make a voice call. The request may includes a handover number or IP address. The mobility manager 164 can await a success response to initiate a hand-in to the WLAN network, at step 812. At step 814, the mobility manager 164 can notify the APM 169 that a GSM to WLAN hand-in has been initiated, and at 706, the APM 169 can mute the microphone to the WLAN network 110 and inform a media manager 165 of the muted status (Step 706 corresponds to method step 706 in FIG. 7). At step 816, the WSP 162 can establish a connection to the WLAN network and inform the mobility manager 164 of the connected status. Accordingly, at step 818, the mobile device 160 is connected to the second network (WLAN 110), while simultaneously being connected to the first network (GSM 110).

At step 820, the mobility manager 164 can inform the APM 169 that the mobile device connected to the GSM network 110 is also connected to the WLAN network 140. At step 710, the APM 169 can mute the microphone on the mobile device that is connected to the GSM network 140 (Step 710 corresponds to method step 710 in FIG. 7). For example, the APM 169 can direct the Media Manager 167 to mute the microphone 190 (See FIG. 4). Recall, the mobile device can support two simultaneous calls through two transmit connections available to the processor on the mobile device. At this point, the audio path to both the WLAN network and the GSM network has been muted. Accordingly, at step 712, the APM 169 can perform a network switch while both audio paths are muted thereby preventing or suppressing an echo condition. Clearly, if the APM 169 completely mutes the audio on the microphone, an echo will be prevented. Alternatively, if the APM 169 reduces the gain of the microphone, the echo will be suppressed. At step 714, the microphone to the WLAN network can be un-muted. And at step 824, the APM 169 can inform the mobility manager 164 that call is connected and active; that is, the audio can be transmitted. For example, the mobility manager 164 can notify a digital audio interface for providing clock frame synchronization for sending voice packets. At step 826, the mobility manager 164 can release the call to the WLAN network.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for suppressing echo on a mobile device during a hand-out, comprising:
within a first call connected to a first network, identifying a second network for supporting a second call;
handing over to the second network for initiating the second call while connected to the first network;
during the handing over to the second network, muting a microphone on the mobile device to the second network;
connecting to the second network in response to the handing over for establishing the second call while maintaining a connection with the first network,
upon connecting to the second network, muting the microphone to the first network;
performing a network switch while the microphone is muted on the first network and muted on the second network;
un-muting the microphone on the second network; and
releasing the first call to terminate a connection to the first network while maintaining the connection to the second network.

2. The method of claim 1, wherein the handover is between a WLAN network and a GSM network.

3. The method of claim 1, wherein the mobile device is one from the set comprising a cell-phone, a personal digital assistant, a portable music player, and a communication device.

4. The method of claim 1, further comprising receiving an indicator message for initiating a handover request from the first network.

5. The method of claim 4, wherein the indicator message is a low coverage message indicating a low network coverage on the first network.

6. The method of claim 5, wherein upon receiving the indicator message, a radio frequency transmission is turned on to register the mobile device with the second network.

7. The method of claim 6, further comprising:
requesting a voice call to the second network using a handover number; and waiting for a success response to initiate a hand-out to the second network.

8. The method of claim 7, further comprising:
upon receiving the success response, notifying the second network; and
upon muting the microphone to the second network, awaiting a connection to the second network.

9. The method of claim 1, further comprising notifying the second network that a connection has registered prior to muting the microphone to the first network.

10. The method of claim 1, further comprising sending a handing over notification in response to the un-muting of the microphone to the second network.

11. A method for suppressing echo on a mobile device during a hand-in, comprising:
within a first call connected to a first network, identifying a second network for supporting a second call;
handing over from the first network to the second network for initiating the second call while connected to the first network;
during the handing over to the second network, muting a microphone on the mobile device to the second network;
establishing the second call to the second network while maintaining the connection to the first network;
upon connecting to the second network, muting the microphone to the first network;
performing a network switch while the microphone is muted on the first network and muted on the second network;
un-muting the microphone on the second network; and
releasing the first call to terminate a connection to the first network while maintaining the connection to the second network.

12. The method of claim 11, wherein the first network is a GSM network and the second network is a WLAN network.

13. The method of claim 11, wherein the handing over further comprises:
receiving an indicator message from the second network; and
registering with the second network in response to receiving the indicator message.

14. The method of claim 13, wherein the indicator message is a strong coverage message indicating a strong network coverage on the second network.

15. The method of claim 11, wherein the handing over further comprises:
sending a hand-in query request from the first network to the second network; and
receiving a hand-in query response at the first network from the second network in response to the hand-in query request.

16. The method of claim 15, further comprises:
notifying the first network that a hand-in has been requested in response to the receiving the hand-in query response for muting the microphone to the first network.

17. The method of claim 11, further comprising notifying a registration to the second network upon establishing the second call to the second network.

18. A system for suppressing echo on a mobile device during a handover, comprising
a WLAN service provider (WSP) for supporting a WLAN call;
a mobility manager communicatively coupled to the WSP for sending and receiving handover requests to a WLAN network;
a GSM service provider (GSP) communicatively coupled to the mobility manager for supporting a GSM call;
an audio policy manager (APM) communicatively coupled to the mobility manager and the GSP for sending and receiving handover requests to a GSM network;

19. The system of claim 18, wherein the audio policy manager:
selectively mutes and un-mutes a microphone that has a common connection to the WLAN network and the GSM network; and
performs a network switch while the microphone is muted on the WLAN network and muted on the GSM network to suppress an echo occurring when the mobile device is connected to both the WLAN network and the GSM network.

20. The system of claim 19, wherein the audio policy manager mutes the microphone on the mobile device to a first network prior to a connection with a second network, and upon establishing a connection with the second network, mutes the microphone on the mobile device to the second network, prior to the network switch.

21. The system of claim 19, wherein the audio policy manager provides a first transmit connection for the first network, a second transmit connection for the second network, and a single receive connection for both the first network and the second network.
